(19) United States
(12) Patent Application Publication
(10) Pub. No.: US 2026/0064416 A1
(43) Pub. Date: Mar. 5, 2026

(54) EXECUTING PARTIAL LONG SYNCHRONIZATION INSTRUCTIONS TO IMPROVE PERFORMANCE IN PROCESSOR DEVICES

(71) Applicant: QUALCOMM Incorporated, San Diego, CA (US)

(72) Inventors: Venkatesh K R, Vijayawada (IN); Suryanarayana Murthy Durbhakula, Hyderabad (IN)

(21) Appl. No.: 18/820,697

(22) Filed: Aug. 30, 2024

(51) Int. Cl. G06F 9/30; G06T 1/20

(52) U.S. Cl. CPC G06F 9/30087; G06F 9/3834

(57) ABSTRACT

Executing partial long synchronization instructions to improve performance in processor devices is disclosed herein. In some aspects, a processor device comprises an instruction processing circuit that is configured to initiate execution of a plurality of memory access instructions in an instruction stream, wherein each memory access instruction of the plurality of memory access instructions is associated with a memory latency. The instruction processing circuit subsequently executes a partial long synchronization instruction that specifies a count of the plurality of memory access instructions. In response to executing the partial long synchronization instruction, the instruction processing circuit halts further execution of the instruction stream, and determines whether data for an ordinal first memory access instruction of the plurality of memory access instructions is ready. If so, the instruction processing circuit completes execution of the ordinal first memory access instruction, and continues execution of the instruction stream.

### TECHNICAL FIELD

The technology of the disclosure relates generally to execution of instructions by a processor device, and, in particular, to efficient synchronization of memory access instructions.

### BACKGROUND

Microprocessors, also referred to herein as “processors” or “processor devices,” perform computational tasks for a wide variety of applications by executing instructions to perform mathematical and logical operations on data. For example, conventional processors may execute memory access instructions to write data to or retrieve data from storage devices such as Level 1 (L1) caches, Level 2 (L2) caches, and/or system memory. Memory access instructions may be associated with different latencies due to variations in the time required to access different types of storage devices. For example, an access to an L1 cache may incur a relatively low memory latency, while an access to an L2 cache may incur a higher memory latency relative to the L1 cache and an access to the system memory may incur a highest memory latency relative to the L1 and L2 caches.

A memory access instruction that is associated with a higher memory latency may raise the possibility that a subsequent instruction that is dependent on the memory access instruction may be ready to execute before the data to be retrieved by the memory access instruction is actually available. Accordingly, to ensure that data retrieved by a memory access instruction is available for use by subsequent instructions, the memory access instruction may be followed by a long synchronization instruction (which may comprise an instruction with a long synchronization modifier, or may comprise a standalone long synchronization instruction). The long synchronization instruction, which may be inserted into a series of instructions by a compiler or other automated tool, acts as a synchronization barrier that causes further execution of instructions to be halted until all pending memory access instructions have returned data. In this manner, the availability of such data for use by subsequent instructions is ensured.

However, the use of long synchronization instructions may negatively impact overall processor performance. For example, if a series of memory access instructions includes both memory access instructions having lower memory latency as well as memory access instructions having higher memory latency, the memory access instructions having lower memory latency may be able to complete earlier, but their dependent instructions would still have to wait until the memory access instructions having higher memory latency complete before the dependent instructions can execute.

### SUMMARY OF THE DISCLOSURE

Aspects disclosed in the detailed description include executing partial long synchronization instructions to improve performance in processor devices. Related apparatus and methods are also disclosed. In this regard, in some exemplary aspects disclosed herein, a processor device, such as a graphics processing unit (GPU), is configured to support a partial long synchronization instruction (e.g., an instruction that provides a partial long synchronization modifier, or a new partial long synchronization instruction, as non-limiting examples). When the partial long synchronization instruction is executed, pending memory access instructions are released from long synchronization in in-order fashion as corresponding data becomes available, and are allowed to continue execution.

In exemplary operation, an instruction processing circuit of the processor device initiates execution of a plurality of memory access instructions in an instruction stream, wherein each memory access instruction of the plurality of memory access instructions is associated with a memory latency. The instruction processing circuit subsequently executes a first partial long synchronization instruction that specifies a count of the plurality of memory access instructions (i.e., that are within the long synchronization group). In response to executing the first partial long synchronization instruction, the instruction processing circuit halts further execution of the instruction stream (e.g., by entering an idle mode). The instruction processing circuit then determines whether data for an ordinal first memory access instruction of the plurality of memory access instructions is ready. If so, the instruction processing circuit completes execution of the ordinal first memory access instruction, and continues execution of the instruction stream.

In some aspects, the processor device may execute a compiler that identifies the plurality of memory access instructions in the instruction stream, and determines whether inserting a first partial long synchronization instruction results in a benefit criteria being satisfied. The benefit criteria may specify, e.g., that a power overhead incurred by inserting the first partial long synchronization instruction is less than a power overhead incurred by a cumulative memory latency of the plurality of memory access instructions, and/or that a performance benefit resulting from inserting the first partial long synchronization instruction is more than a performance benefit threshold. If the processor device determines that inserting the first partial long synchronization instruction results in the benefit criteria being satisfied, the processor device executing the compiler inserts the first partial long synchronization instruction following an ordinal last memory access instruction of the plurality of memory access instructions.

Some aspects may provide that the instruction processing circuit further executes one or more instructions that are not dependent on an uncompleted memory access instruction. The processor device in some aspects may perform early release of a target register of the ordinal first memory access instruction (e.g., responsive to determining that no uncompleted instructions depend on the target register). The instruction processing circuit subsequently executes a second partial long synchronization instruction that specifies a count of the remaining memory access instructions of the plurality of memory access instructions.

In another aspect, a processor device is disclosed. The processor device comprises an instruction processing circuit that is configured to initiate execution of a plurality of memory access instructions in an instruction stream, wherein each memory access instruction of the plurality of memory access instructions is associated with a memory latency. The instruction processing circuit is further configured to subsequently execute a first partial long synchronization instruction that specifies a count of the plurality of memory access instructions. The instruction processing circuit is also configured to, responsive to executing the first partial long synchronization instruction, halt further execution of the instruction stream, and determine whether data for an ordinal first memory access instruction of the plurality of memory access instructions is ready. The instruction processing circuit is additionally configured to, responsive to determining that the data for the ordinal first memory access instruction is ready, complete execution of the ordinal first memory access instruction, and continue execution of the instruction stream.

In another aspect, a processor device is disclosed. The processor device comprises means for initiating execution of a plurality of memory access instructions in an instruction stream, wherein each memory access instruction of the plurality of memory access instructions is associated with a memory latency. The processor device further comprises means for subsequently executing a partial long synchronization instruction that specifies a count of the plurality of memory access instructions. The processor device also comprises means for halting further execution of the instruction stream, responsive to executing the partial long synchronization instruction. The processor device additionally comprises means for determining whether data for an ordinal first memory access instruction of the plurality of memory access instructions is ready. The processor device further comprises means for completing execution of the ordinal first memory access instruction, responsive to determining that the data for the ordinal first memory access instruction is ready. The processor device also comprises means for continuing execution of the instruction stream.

In another aspect, a method for executing partial long synchronization instructions to improve performance in processor devices is disclosed. The method comprises initiating execution, by an instruction processing circuit of a processor device, of a plurality of memory access instructions in an instruction stream, wherein each memory access instruction of the plurality of memory access instructions is associated with a memory latency. The method further comprises subsequently executing, by the instruction processing circuit, a first partial long synchronization instruction that specifies a count of the plurality of memory access instructions. The method also comprises, responsive to executing the first partial long synchronization instruction, halting, by the instruction processing circuit, further execution of the instruction stream, and determining, by the instruction processing circuit, that data for an ordinal first memory access instruction of the plurality of memory access instructions is ready. The method additionally comprises, responsive to determining that the data for the ordinal first memory access instruction is ready, completing, by the instruction processing circuit, execution of the ordinal first memory access instruction, and continuing, by the instruction processing circuit, execution of the instruction stream.

In another aspect, a non-transitory computer-readable medium is disclosed. The non-transitory computer-readable medium stores computer-executable instructions that, when executed, cause a processor device to initiate execution of a plurality of memory access instructions in an instruction stream, wherein each memory access instruction of the plurality of memory access instructions is associated with a memory latency. The computer-executable instructions further cause the processor device to subsequently execute a first partial long synchronization instruction that specifies a count of the plurality of memory access instructions. The computer-executable instructions also cause the processor device to, responsive to executing the first partial long synchronization instruction, halt further execution of the instruction stream, and determine whether data for an ordinal first memory access instruction of the plurality of memory access instructions is ready. The computer-executable instructions additionally cause the processor device to, responsive to determining that the data for the ordinal first memory access instruction is ready, complete execution of the ordinal first memory access instruction, and continue execution of the instruction stream.

### BRIEF DESCRIPTION OF THE FIGURES

FIG. 1 shows an instruction stream illustrating the use and drawbacks of conventional long synchronization instructions in processor devices;

FIG. 2 is a block diagram of an exemplary processor-based device including an instruction processing circuit configured to execute partial long synchronization instructions to improve processor performance, according to some aspects;

FIG. 3 shows an instruction stream illustrating the use and benefits of partial long synchronization instructions in processor devices, according to some aspects;

FIGS. 4A-4B provide a flowchart illustrating exemplary operations of the instruction processing circuit of FIG. 2 for executing partial long synchronization instructions, according to some aspects; and

FIG. 5 is a block diagram of an exemplary processor-based device that can include the instruction processing circuit of FIG. 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise expressly indicated.

Aspects disclosed in the detailed description include executing partial long synchronization instructions to improve performance in processor devices. Related apparatus and methods are also disclosed. In this regard, in some exemplary aspects disclosed herein, a processor device, such as a graphics processing unit (GPU), is configured to support a partial long synchronization instruction (e.g., an instruction that provides a partial long synchronization modifier, or a new partial long synchronization instruction, as non-limiting examples). When the partial long synchronization instruction is executed, pending memory access instructions are released from long synchronization in in-order fashion as corresponding data becomes available, and are allowed to continue execution.

In exemplary operation, an instruction processing circuit of the processor device initiates execution of a plurality of memory access instructions in an instruction stream, wherein each memory access instruction of the plurality of memory access instructions is associated with a memory latency. The instruction processing circuit subsequently executes a first partial long synchronization instruction that specifies a count of the plurality of memory access instructions (i.e., that are within the long synchronization group). In response to executing the first partial long synchronization instruction, the instruction processing circuit halts further execution of the instruction stream (e.g., by entering an idle mode). The instruction processing circuit then determines whether data for an ordinal first memory access instruction of the plurality of memory access instructions is ready. If so, the instruction processing circuit completes execution of the ordinal first memory access instruction, and continues execution of the instruction stream.

In some aspects, the processor device may execute a compiler that identifies the plurality of memory access instructions in the instruction stream, and determines whether inserting a first partial long synchronization instruction results in a benefit criteria being satisfied. The benefit criteria may specify, e.g., that a power overhead incurred by inserting the first partial long synchronization instruction is less than a power overhead incurred by a cumulative memory latency of the plurality of memory access instructions, and/or that a performance benefit resulting from inserting the first partial long synchronization instruction is more than a performance benefit threshold. If the processor device determines that inserting the first partial long synchronization instruction results in the benefit criteria being satisfied, the processor device executing the compiler inserts the first partial long synchronization instruction following an ordinal last memory access instruction of the plurality of memory access instructions.

Some aspects may provide that the instruction processing circuit further executes one or more instructions that are not dependent on an uncompleted memory access instruction. The processor device in some aspects may perform early release of a target register of the ordinal first memory access instruction (e.g., responsive to determining that no uncompleted instructions depend on the target register). The instruction processing circuit subsequently executes a second partial long synchronization instruction that specifies a count of the remaining memory access instructions of the plurality of memory access instructions.

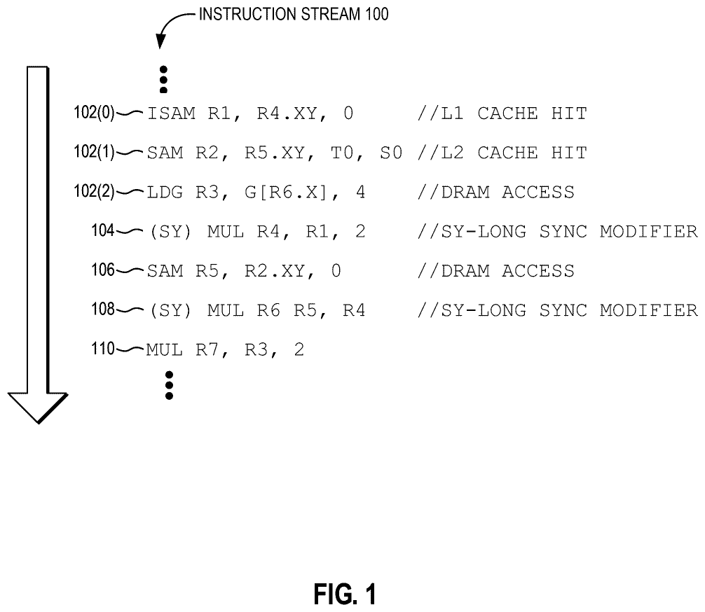

Before the use of partial long synchronization instructions to improve processor performance is described, the challenges with conventional long synchronization are first discussed. In this regard, FIG. 1 shows an instruction stream 100 that may be executed by an instruction processing circuit (not shown) of a processor device such as a GPU (not shown). The instruction stream 100 comprises three (3) memory access instructions 102(0)-102(2): an image sample (ISAM) memory access instruction 102(0), a sample (SAM) memory access instruction 102(1), and a load-from-global-memory (LDG) memory access instruction 102(2). In this example, it is assumed that the ISAM memory access instruction 102(0) results in a hit on a Level 1 (L1) cache, the SAM memory access instruction 102(1) results in a hit on a Level 2 (L2) cache, and the LDG memory access instruction 102(2) requires an access to a Dynamic Random Access Memory (DRAM) system memory device. Thus, the memory access operation resulting from executing the ISAM memory access instruction 102(0) will incur a lowest memory latency of the three (3) memory access instructions 102(0)-102(2), while the memory access operation resulting from executing the SAM memory access instruction 102(1) will incur a higher memory latency and the memory access operation resulting from executing the LDG memory access instruction 102(2) will incur a highest memory latency.

When the instruction stream 100 is processed, execution of the memory access instructions 102(0)-102(2) will be initiated by the instruction processing circuit. The instruction processing circuit then executes a multiply (MUL) instruction 104 having a long synchronization (SY) modifier. The SY modifier causes execution of the instruction stream 100 to be halted until the results of executing all pending memory access instructions, including the memory access instructions 102(0)-102(2), have become available. After the memory access instructions 102(0)-102(2) have obtained results, the execution of the MUL instruction 104 is completed. A SAM memory access instruction 106 is executed next, followed by another MUL instruction 108 with an SY modifier. Again, execution of the instruction stream 100 is halted until the results of executing all pending memory access instructions (which at this point is just the SAM memory access instruction 106) have become available. Once data for the SAM memory access instruction 106 is received, execution of the MUL instruction 108 completes, and is followed by execution of a MUL instruction 110.

Note, however, that even though the results of executing the ISAM memory access instruction 102(0) and the SAM memory access instruction 102(1) become available before the results of executing the LDG memory access instruction 102(2) due to their lower memory latency, none of the memory access instructions 102(0)-102(2) are allowed to complete execution until the results of executing the memory access instructions 102(0)-102(2) having the highest memory latency (i.e., the LDG memory access instruction 102(2), in this example) are available. Accordingly, it is desirable to provide a mechanism by which data received by the lower latency memory access instructions 102(0) and 102(1) can be used by subsequent instructions while the data for the LDG memory access instruction 102(2) is still pending.

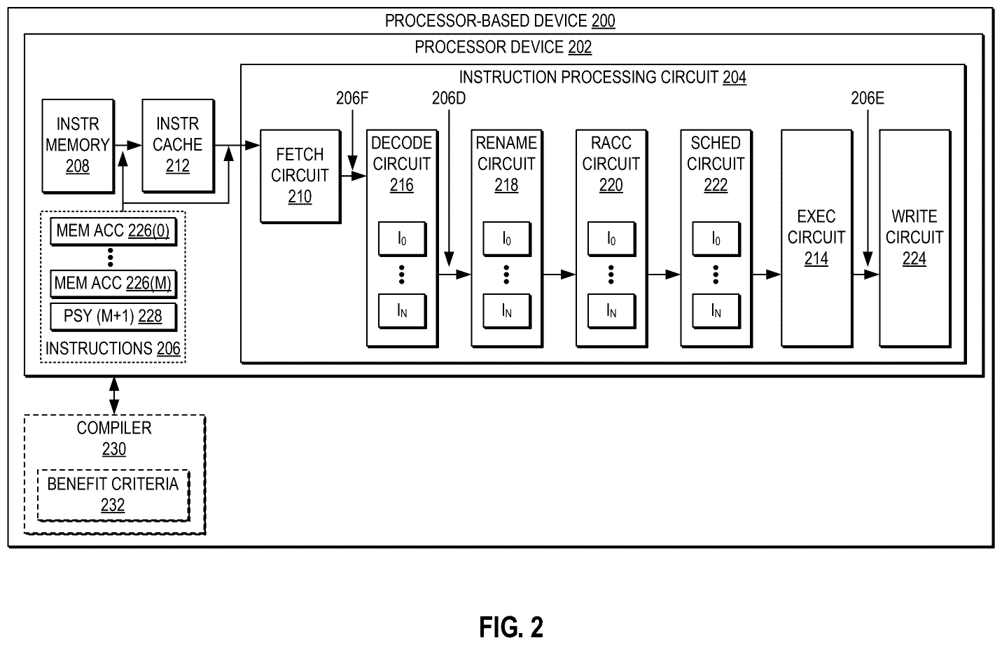

In this regard, FIG. 2 is a diagram of an exemplary processor-based device 200 that includes a processor device 202 that is configured to execute partial long synchronization instructions to improve processor performance. The processor device 202, which also may be referred to as a “processor core” or a “central processing unit (CPU) core,” may be an in-order or an out-of-order processor (OoP), and/or may be one of a plurality of processor devices 202 provided by the processor-based device 200. In some aspects, the processor device 202 may comprise a GPU.

In the example of FIG. 2, the processor device 202 includes an instruction processing circuit 204 that includes one or more instruction pipelines Io-IN for processing a plurality of instructions 206 fetched from an instruction memory (captioned as “INSTR MEMORY” in FIG. 2) 208 by a fetch circuit 210 for execution. The instruction memory 208 may be provided in or as part of a system memory (not shown) in the processor-based device 200, as a non-limiting example. An instruction cache (captioned as “INSTR CACHE” in FIG. 2) 212 may also be provided in the processor device 202 to cache the instructions 206 fetched from the instruction memory 208 to reduce latency in the fetch circuit 210.

The fetch circuit 210 in the example of FIG. 2 is configured to provide the instructions 206 as fetched instructions 206F into the one or more instruction pipelines I₀-I_{N} in the instruction processing circuit 204 to be pre-processed, before the fetched instructions 206F reach an execution circuit (captioned as “EXEC CIRCUIT” in FIG. 2) 214 to be executed. The instruction pipelines I₀-I_{N} are provided across different processing circuits or stages of the instruction processing circuit 204 to pre-process and process the fetched instructions 206F in a series of steps that can be performed concurrently to increase throughput prior to execution of the fetched instructions 206F by the execution circuit 214.

With continuing reference to FIG. 2, the instruction processing circuit 204 includes a decode circuit 216 configured to decode the fetched instructions 206F fetched by the fetch circuit 210 into decoded instructions 206D to determine the instruction type and actions required. The instruction type and action required encoded in the decoded instructions 206D may also be used to determine in which instruction pipeline Io-IN the decoded instructions 206D should be placed. In this example, the decoded instructions 206D are placed in one or more of the instruction pipelines I₀-I_{N} and are next provided to a rename circuit 218 in the instruction processing circuit 204. The rename circuit 218 is configured to determine if any register names in the decoded instructions 206D should be renamed to decouple any register dependencies that would prevent parallel or out-of-order processing.

The instruction processing circuit 204 in the processor device 202 in FIG. 2 also includes a register access circuit (captioned as “RACC CIRCUIT” in FIG. 2) 220. The register access circuit 220 is configured to access a physical register in a physical register file (PRF) (not shown) based on a mapping entry mapped to a logical register in a register mapping table (RMT) (not shown) of a source register operand of a decoded instruction 206D to retrieve a produced value from an executed instruction 206E in the execution circuit 214. The register access circuit 220 is also configured to provide the retrieved produced value from an executed instruction 206E as the source register operand of a decoded instruction 206D to be executed.

Also, in the instruction processing circuit 204, a scheduler circuit (captioned as “SCHED CIRCUIT” in FIG. 2) 222 is provided in the instruction pipeline Io-IN and is configured to store decoded instructions 206D in reservation entries until all source register operands for the decoded instruction 206D are available. The scheduler circuit 222 issues decoded instructions 206D that are ready to be executed to the execution circuit 214. A write circuit 224 is also provided in the instruction processing circuit 204 to write back or commit produced values from executed instructions 206E to memory (such as the PRF), cache memory, or system memory.

In the example of FIG. 2, the instructions 206 include a plurality of memory access instructions (captioned as “MEM ACC” in FIG. 2) 226(0)-226(M). Each of the memory access instructions 226(0)-226(M) may comprise an instruction for loading data from system memory (not shown) or cache, such as an ISAM instruction, a SAM instruction, or an LDG instruction, as non-limiting examples. As noted above, conventional long synchronization mechanisms prevent earlier memory access instructions such as the memory access instruction 226(0) from completing execution until the results of all of the memory access instructions 226(0)-226(M) are available. This is true even if the earlier memory access instruction 226(0) has a lower memory latency than subsequent memory access instructions such as the memory access instruction 226(M).

Accordingly, the instruction processing circuit 204 is configured to execute a partial long synchronization instruction (captioned as “PSY” in FIG. 2) 228. In exemplary operation, the instruction processing circuit 204 of the processor device 202 initiates execution of the plurality of memory access instructions 226(0)-226(M), and subsequently executes the partial long synchronization instruction 228, which specifies a count (i.e., M+1) of the plurality of memory access instructions 226(0)-226(M). In response to executing the partial long synchronization instruction 228, the instruction processing circuit 204 halts further execution of the instructions 206. The instruction processing circuit 204 then determines whether data for an ordinal first memory access instruction (i.e., the memory access instruction 226(0) in this example) of the plurality of memory access instructions 226(0)-226(M) is ready. If not, the instruction processing circuit 204 continues waiting. However, if the instruction processing circuit 204 determines that the data for the ordinal first memory access instruction 226(0) is ready, the instruction processing circuit 204 completes execution of the ordinal first memory access instruction 226(0), and then continues execution of the instructions 206.

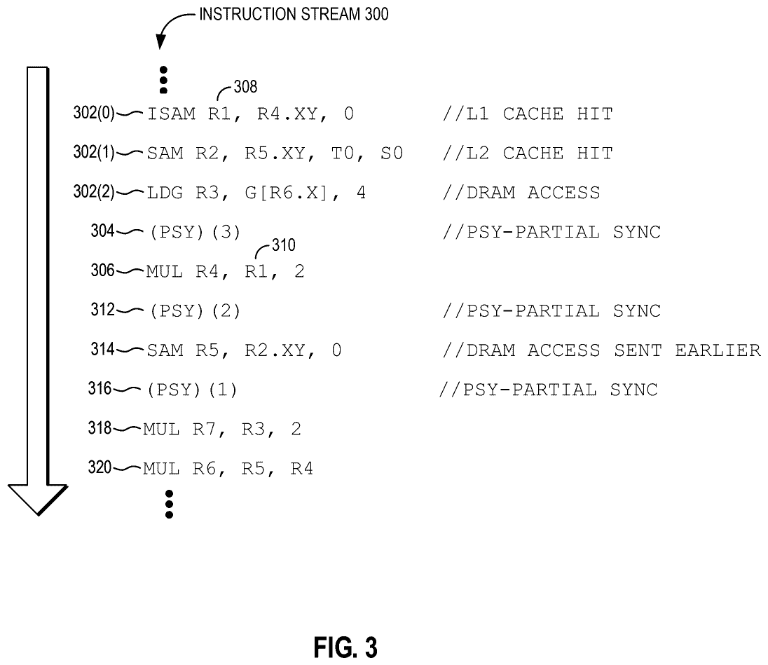

In some aspects, the processor device 202 may execute a compiler 230 that identifies the plurality of memory access instructions 226(0)-226(M), and determines whether inserting the partial long synchronization instruction 228 results in a benefit criteria 232 being satisfied. For example, the benefit criteria 232 may specify that a power overhead incurred by inserting the partial long synchronization instruction 228 is less than a power overhead incurred by a cumulative memory latency of the plurality of memory access instructions 226(0)-226(M), and/or may specify that a performance benefit resulting from inserting the partial long synchronization instruction 228 is more than a performance benefit threshold. If the compiler 230 determines that inserting the partial long synchronization instruction 228 results in the benefit criteria 232 being satisfied, the compiler 230 inserts the partial long synchronization instruction 228 following an ordinal last memory access instruction (i.e., the memory access instruction 226(M) in this example) of the plurality of memory access instructions 226(0)-226(M). An example instruction stream, along with a discussion of the effects and benefits of the partial long synchronization instruction 228, is discussed in greater detail below with respect to FIG. 3.

FIG. 3 shows an instruction stream 300 including partial long synchronization instructions that may be executed by the instruction processing circuit 204 of the processor device 202 of FIG. 2. Like the instruction stream 100 of FIG. 1, the instruction stream 300 comprises three (3) memory access instructions 302(0)-302(2): an ISAM memory access instruction 302(0), a SAM memory access instruction 302(1), and an LDG memory access instruction 302(2). In the example of FIG. 3, it is assumed that the ISAM memory access instruction 302(0) results in a hit on a L1 cache, the SAM memory access instruction 302(1) results in a hit on a L2 cache, and the LDG memory access instruction 302(2) requires an access to a DRAM system memory device.

When the instruction stream 300 is processed, execution of the memory access instructions 302(0)-302(2) will be initiated by the instruction processing circuit 204. The instruction processing circuit 204 then executes a partial long synchronization (PSY) instruction 304 that groups the previous three (3) pending memory access instructions 302(0)-302(2). Upon executing the PSY instruction 304, the instruction processing circuit 204 halts execution of the instruction stream 300 until results of the ordinal first memory access instruction that is pending (i.e., the ISAM memory access instruction 302(0), in this example) are available. When the results of the ordinal first memory access instruction 302(0) are available, the instruction processing circuit 204 completes execution of the memory access instruction 302(0), and then continues execution of the instruction stream 300. In FIG. 3, this results in the MUL instruction 306, which depends on the results of the ISAM memory access instruction 302(0) (stored in the register R1), being able to execute while the results of the SAM memory access instruction 302(1) and the LDG memory access instruction 302(2) are still pending. Once the MUL instruction 306 has completed execution, the processor device 202 can proceed with performing early release of the register R1 that was acting as a target register 308 for the ISAM memory access instruction 302(0) and a source register 310 for the MUL instruction 306, thereby reducing register pressure.

As execution of the instruction stream 300 continues, a second PSY instruction 312 that groups the previous two (2) pending memory access instructions 302(1)-302(2) is executed. Execution of the instruction stream 300 is then halted again by the instruction processing circuit 204 until the results of the next in-order memory access instruction 302(1) are available. After data retrieved by the memory access instruction 302(1) is stored in the register R2, the SAM memory access instruction 314 is executed by the instruction processing circuit 204. Finally, a third PSY instruction 316 that includes the one (1) pending memory access instruction 302(2) is executed. The instruction processing circuit 204 halts execution of the instruction stream 300 until the results of executing the LDG memory access instruction 302(2) are available. At that point, execution of the instruction stream 300 resumes with the MUL instruction 318 executing, followed by execution of the MUL instruction 320.

As seen in FIG. 3, the use of the PSY instructions 304, 312, 316 can hide cycles of early release instruction computations as other memory access instructions 302(0)-302(2) are waiting for data. For instance, in the example of FIG. 3, once the data retrieved by the ISAM memory access instruction 302(0) is ready in register R1, the MUL instruction 306 is computed while the memory access instructions 302(1), 302(2) are still waiting for data. Consequently, the processor cycles consumed by the MUL instruction 306 will be “hidden” by the pending memory operations. Similarly, because of the PSY instruction 312, the SAM memory access instruction 314 needs only to wait for the SAM memory access instruction 302(1) to complete.

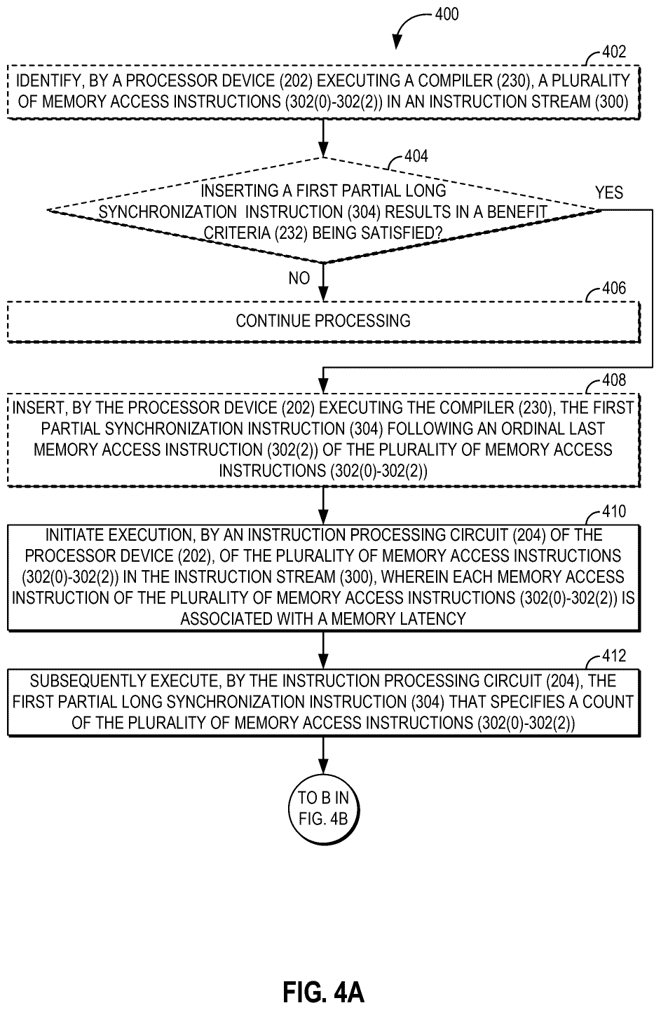

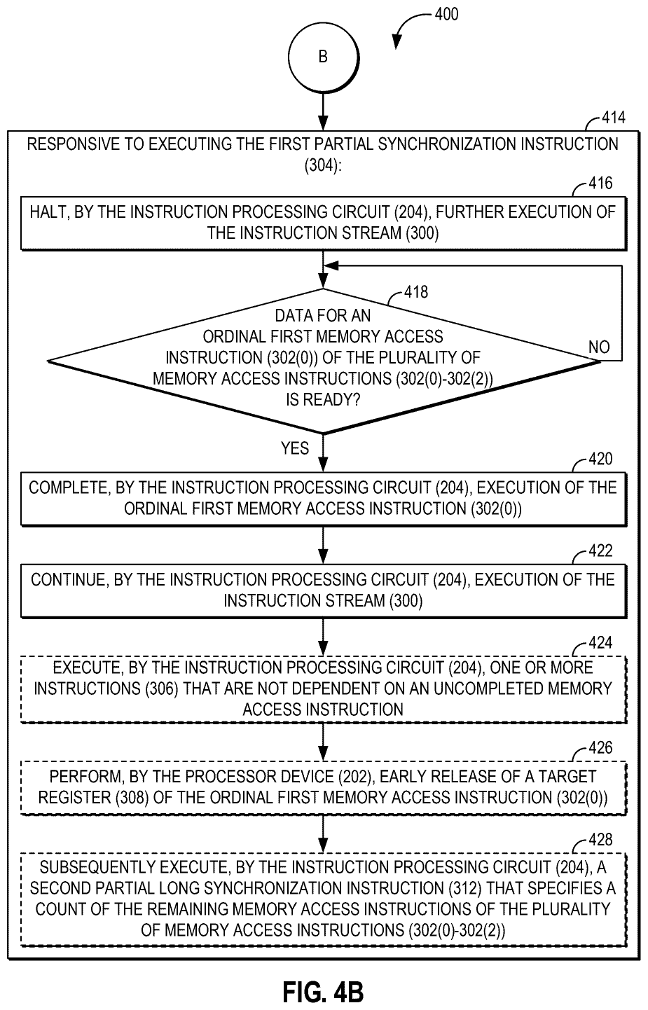

To illustrate operations performed by the instruction processing circuit 204 of FIG. 2 for executing partial long synchronization instructions according to some aspects, FIGS. 4A-4B provide a flowchart showing exemplary operations 400. For the sake of clarity, elements of FIGS. 2 and 3 are referenced in describing FIGS. 4A-4B. It is to be understood that some aspects may provide that some operations illustrated in FIGS. 4A-4B may be performed in an order other than that illustrated herein, and/or may be omitted.

The exemplary operations 400 according to some aspects begin in FIG. 4A with a processor device (e.g., the processor device 202 of FIG. 2), executing a compiler (such as the compiler 230 of FIG. 2), identifying a plurality of memory access instructions (e.g., the memory access instructions 302(0)-302(2) of FIG. 3) in an instruction stream (such as the instruction stream 300 of FIG. 3) (block 402). The processor device 202 determines whether inserting a first partial long synchronization instruction (e.g., the partial long synchronization instruction 304 of FIG. 3) results in a benefit criteria (e.g., the benefit criteria 232 of FIG. 2) being satisfied (block 404). As non-limiting examples, the benefit criteria 232 may specify that a power overhead incurred by inserting the first partial long synchronization instruction 304 is less than a power overhead incurred by a cumulative memory latency of the plurality of memory access instructions 302(0)-302(2), and/or that a performance benefit resulting from inserting the first partial long synchronization instruction 304 is more than a performance benefit threshold. If not, processing continues in conventional fashion (block 406). However, if the processor device 202 determines at decision block 404 that inserting the first partial long synchronization instruction 304 results in the benefit criteria 232 being satisfied, the processor device 202 executing the compiler 230 inserts the first partial long synchronization instruction 304 following an ordinal last memory access instruction (such as the memory access instruction 302(2) of FIG. 3) of the plurality of memory access instructions 302(0)-302(2) (block 408).

An instruction processing circuit (such as the instruction processing circuit 204 of FIG. 2) of the processor device 202 initiates execution of the plurality of memory access instructions 302(0)-302(2) in the instruction stream 300, wherein each memory access instruction of the plurality of memory access instructions 302(0)-302(2) is associated with a memory latency (block 410). The instruction processing circuit 204 subsequently executes the first partial long synchronization instruction 304 that specifies a count of the plurality of memory access instructions 302(0)-302(2) (block 412). The exemplary operations 400 continue at block 414 of FIG. 4B.

Referring now to FIG. 4B, in response to execution the first partial long synchronization instruction 304, the instruction processing circuit 204 performs a series of operations (block 414). The instruction processing circuit 204 halts further execution of the instruction stream 300 (block 416). The instruction processing circuit 204 then determines whether data for an ordinal first memory access instruction (e.g., the memory access instruction 302(0) of FIG. 3) of the plurality of memory access instructions 302(0)-302(2) is ready (block 418). If not, the instruction processing circuit 204 continues waiting. However, if the instruction processing circuit 204 determines at decision block 418 that the data for the ordinal first memory access instruction 302(0) is ready, the instruction processing circuit 204 completes execution of the ordinal first memory access instruction 302(0) (block 420). The instruction processing circuit 204 then continues execution of the instruction stream 300 (block 422).

Some aspects may provide that the instruction processing circuit 204 further executes execute one or more instructions (such as the instruction 306 of FIG. 3) that are not dependent on an uncompleted memory access instruction (block 424). The processor device 202 in some aspects may perform early release of a target register (e.g., the target register 308 of FIG. 3) of the ordinal first memory access instruction 302(0) (block 426). In some aspects, the processor device 202 may perform the early release of the target register 308 responsive to determining that no uncompleted instructions depend on the target register 308. The instruction processing circuit 204 subsequently executes a second partial long synchronization instruction (e.g., the partial long synchronization instruction 312 of FIG. 3) that specifies a count of the remaining memory access instructions of the plurality of memory access instructions 302(0)-302(2) (block 428).

The instruction processing circuit according to aspects disclosed herein and discussed with reference to FIGS. 2, 3, and 4A-4B may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

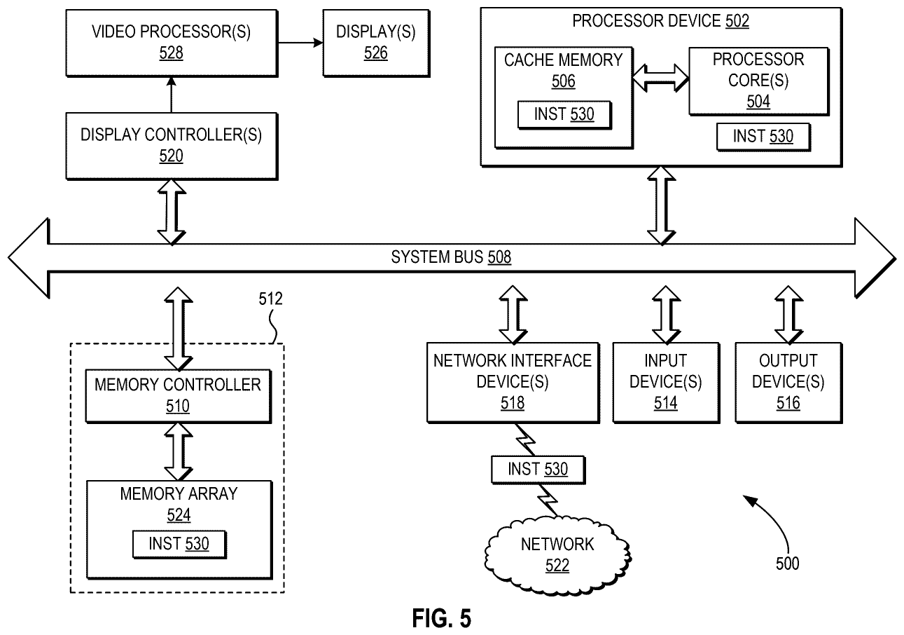

In this regard, FIG. 5 illustrates an example of a processor-based device 500. In this example, the processor-based device 500 includes a processor device 502, which corresponds in functionality to the processor device 202 of FIG. 2 and comprises one or more processor cores 504 coupled to a cache memory 506. The processor device 502 is also coupled to a system bus 508 and can intercouple devices included in the processor-based device 500. As is well known, the processor device 502 communicates with these other devices by exchanging address, control, and data information over the system bus 508. For example, the processor device 502 can communicate bus transaction requests to a memory controller 510. Although not illustrated in FIG. 5, multiple system buses 508 could be provided, wherein each system bus 508 constitutes a different fabric.

Other devices may be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including, but not limited to, input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include the memory controller 510 coupled to one or more memory arrays 524.

The processor device 502 may also be configured to access the display controller(s) 520 over the system bus 508 to control information sent to one or more displays 526. The display controller(s) 520 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc.

The processor-based device 500 in FIG. 5 may include a set of instructions (captioned as “INST” in FIG. 5) 530 that may be executed by the processor device 502 for any application desired according to the instructions. The instructions 530 may be stored in the memory system 512, the processor device 502, and/or the cache memory 506, each of which may comprise an example of a non-transitory computer-readable medium. The instructions 530 may also reside, completely or at least partially, within the memory system 512 and/or within the processor device 502 during their execution. The instructions 530 may further be transmitted or received over the network 522, such that the network 522 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 530. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor device, comprising an instruction processing circuit configured to:
initiate execution of a plurality of memory access instructions in an instruction stream, wherein each memory access instruction of the plurality of memory access instructions is associated with a memory latency;
subsequently execute a first partial long synchronization instruction that specifies a count of the plurality of memory access instructions; and
responsive to executing the first partial long synchronization instruction:
   halt further execution of the instruction stream;
   determine whether data for an ordinal first memory access instruction of the plurality of memory access instructions is ready; and
   responsive to determining that the data for the ordinal first memory access instruction is ready:
      complete execution of the ordinal first memory access instruction; and
      continue execution of the instruction stream.

2. The processor device of clause 1, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

3. The processor device of any one of clauses 1-2, wherein the processor device comprises a graphics processing unit (GPU).

4. The processor device of any one of clauses 1-3, wherein the instruction processing circuit is configured to continue execution of the instruction stream by being configured to:
execute one or more instructions that are not dependent on an uncompleted memory access instruction; and
subsequently execute a second partial long synchronization instruction that specifies a count of the remaining memory access instructions of the plurality of memory access instructions.

5. The processor device of clause 4, wherein the instruction processing circuit is further configured to, prior to executing the second partial long synchronization instruction, perform early release of the target register of the ordinal first memory access instruction.

6. The processor device of any one of clauses 1-5, wherein the processor device is configured to:
identify, by executing a compiler, the plurality of memory access instructions in the instruction stream; and
insert the first partial long synchronization instruction following an ordinal last memory access instruction of the plurality of memory access instructions.

7. The processor device of clause 6, wherein the processor device is configured to insert the first partial long synchronization instruction responsive to determining that inserting the first partial long synchronization instruction results in a benefit criteria being satisfied.

8. The processor device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

9. A processor device, comprising:
means for initiating execution of a plurality of memory access instructions in an instruction stream, wherein each memory access instruction of the plurality of memory access instructions is associated with a memory latency;
means for subsequently executing a partial long synchronization instruction that specifies a count of the plurality of memory access instructions;
means for halting further execution of the instruction stream, responsive to executing the partial long synchronization instruction;
means for determining whether data for an ordinal first memory access instruction of the plurality of memory access instructions is ready;
means for completing execution of the ordinal first memory access instruction, responsive to determining that the data for the ordinal first memory access instruction is ready; and
means for continuing execution of the instruction stream.

10. A method for executing partial long synchronization instructions to improve processor performance in processor devices, comprising:
initiating execution, by an instruction processing circuit of a processor device, of a plurality of memory access instructions in an instruction stream, wherein each memory access instruction of the plurality of memory access instructions is associated with a memory latency;
subsequently executing, by the instruction processing circuit, a first partial long synchronization instruction that specifies a count of the plurality of memory access instructions; and
responsive to executing the first partial long synchronization instruction:
   halting, by the instruction processing circuit, further execution of the instruction stream;
   determining, by the instruction processing circuit, that data for an ordinal first memory access instruction of the plurality of memory access instructions is ready; and
   responsive to determining that the data for the ordinal first memory access instruction is ready:
      completing, by the instruction processing circuit, execution of the ordinal first memory access instruction; and
      continuing, by the instruction processing circuit, execution of the instruction stream.

11. The method of clause 10, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

12. The method of any one of clauses 10-11, wherein continuing execution of the instruction stream comprises:
executing, by the instruction processing circuit, one or more instructions that are not dependent on an uncompleted memory access instruction; and
subsequently executing, by the instruction processing circuit, a second partial long synchronization instruction that specifies a count of the remaining memory access instructions of the plurality of memory access instructions.

13. The method of clause 12, further comprising, prior to executing the second partial long synchronization instruction, performing, by the processor device, early release of the target register of the ordinal first memory access instruction.

14. The method of any one of clauses 10-13, further comprising:
identifying, by the processor device executing a compiler, the plurality of memory access instructions in the instruction stream; and
inserting, by the processor device executing the compiler, the first partial long synchronization instruction following an ordinal last memory access instruction of the plurality of memory access instructions.

15. The method of clause 14, wherein inserting the first partial long synchronization instruction is responsive to determining that inserting the first partial long synchronization instruction results in a benefit criteria being satisfied.

16. A non-transitory computer-readable medium, having stored thereon computer-executable instructions that, when executed, cause a processor device to:
initiate execution of a plurality of memory access instructions in an instruction stream, wherein each memory access instruction of the plurality of memory access instructions is associated with a memory latency;
subsequently execute a first partial long synchronization instruction that specifies a count of the plurality of memory access instructions; and
responsive to executing the first partial long synchronization instruction:
   halt further execution of the instruction stream;
   determine whether data for an ordinal first memory access instruction of the plurality of memory access instructions is ready; and
   responsive to determining that the data for the ordinal first memory access instruction is ready:
      complete execution of the ordinal first memory access instruction; and
      continue execution of the instruction stream.

17. The non-transitory computer-readable medium of clause 16, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

18. The non-transitory computer-readable medium of any one of clauses 16-17, wherein the computer-executable instructions cause the processor device to continue execution of the instruction stream by causing the processor device to:
execute one or more instructions that are not dependent on an uncompleted memory access instruction; and
subsequently execute a second partial long synchronization instruction that specifies a count of the remaining memory access instructions of the plurality of memory access instructions.

19. The non-transitory computer-readable medium of any one of clauses 16-18, wherein the computer-executable instructions further cause the processor device to:
identify, by executing a compiler, the plurality of memory access instructions in the instruction stream; and
insert the first partial long synchronization instruction following an ordinal last memory access instruction of the plurality of memory access instructions.

20. The non-transitory computer-readable medium of clause 19, wherein the computer-executable instructions further cause the processor device to insert the first partial long synchronization instruction responsive to determining that inserting the first partial long synchronization instruction results in a benefit criteria being satisfied.

1. A processor device, comprising an instruction processing circuit configured to:
initiate execution of a plurality of memory access instructions in an instruction stream, wherein each memory access instruction of the plurality of memory access instructions is associated with a memory latency;
subsequently execute a first partial synchronization instruction that specifies a count of the plurality of memory access instructions; and
responsive to executing the first partial synchronization instruction:
halt further execution of the instruction stream;
determine whether data for an ordinal first memory access instruction of the plurality of memory access instructions is ready; and
responsive to determining that the data for the ordinal first memory access instruction is ready:
complete execution of the ordinal first memory access instruction; and
continue execution of the instruction stream.

2. The processor device of claim 1, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

3. The processor device of claim 1, wherein the processor device comprises a graphics processing unit (GPU).

4. The processor device of claim 1, wherein the instruction processing circuit is configured to continue execution of the instruction stream by being configured to:
execute one or more instructions that are not dependent on an uncompleted memory access instruction; and
subsequently execute a second partial synchronization instruction that specifies a count of the remaining memory access instructions of the plurality of memory access instructions.

5. The processor device of claim 4, wherein the instruction processing circuit is further configured to, prior to executing the second partial synchronization instruction, perform early release of the target register of the ordinal first memory access instruction.

6. The processor device of claim 1, wherein the processor device is configured to:
identify, by executing a compiler, the plurality of memory access instructions in the instruction stream; and
insert the first partial synchronization instruction following an ordinal last memory access instruction of the plurality of memory access instructions.

7. The processor device of claim 6, wherein the processor device is configured to insert the first partial synchronization instruction responsive to determining that inserting the first partial synchronization instruction results in a benefit criteria being satisfied.

8. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

9. A processor device, comprising:
means for initiating execution of a plurality of memory access instructions in an instruction stream, wherein each memory access instruction of the plurality of memory access instructions is associated with a memory latency;
means for subsequently executing a partial synchronization instruction that specifies a count of the plurality of memory access instructions;
means for halting further execution of the instruction stream, responsive to executing the partial synchronization instruction;
means for determining whether data for an ordinal first memory access instruction of the plurality of memory access instructions is ready;
means for completing execution of the ordinal first memory access instruction, responsive to determining that the data for the ordinal first memory access instruction is ready; and
means for continuing execution of the instruction stream.

10. A method for executing partial synchronization instructions to improve processor performance in processor devices, comprising:
initiating execution, by an instruction processing circuit of a processor device, of a plurality of memory access instructions in an instruction stream, wherein each memory access instruction of the plurality of memory access instructions is associated with a memory latency;
subsequently executing, by the instruction processing circuit, a first partial synchronization instruction that specifies a count of the plurality of memory access instructions; and
responsive to executing the first partial synchronization instruction:
halting, by the instruction processing circuit, further execution of the instruction stream;
determining, by the instruction processing circuit, that data for an ordinal first memory access instruction of the plurality of memory access instructions is ready; and
responsive to determining that the data for the ordinal first memory access instruction is ready:
completing, by the instruction processing circuit, execution of the ordinal first memory access instruction; and
continuing, by the instruction processing circuit, execution of the instruction stream.

11. The method of claim 10, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

12. The method of claim 10, wherein continuing execution of the instruction stream comprises:
executing, by the instruction processing circuit, one or more instructions that are not dependent on an uncompleted memory access instruction; and
subsequently executing, by the instruction processing circuit, a second partial synchronization instruction that specifies a count of the remaining memory access instructions of the plurality of memory access instructions.

13. The method of claim 12, further comprising, prior to executing the second partial synchronization instruction, performing, by the processor device, early release of the target register of the ordinal first memory access instruction.

14. The method of claim 10, further comprising:
identifying, by the processor device executing a compiler, the plurality of memory access instructions in the instruction stream; and
inserting, by the processor device executing the compiler, the first partial synchronization instruction following an ordinal last memory access instruction of the plurality of memory access instructions.

15. The method of claim 14, wherein inserting the first partial synchronization instruction is responsive to determining that inserting the first partial synchronization instruction results in a benefit criteria being satisfied.

16. A non-transitory computer-readable medium, having stored thereon computer-executable instructions that, when executed, cause a processor device to:
initiate execution of a plurality of memory access instructions in an instruction stream, wherein each memory access instruction of the plurality of memory access instructions is associated with a memory latency;
subsequently execute a first partial synchronization instruction that specifies a count of the plurality of memory access instructions; and
responsive to executing the first partial synchronization instruction:
halt further execution of the instruction stream;
determine whether data for an ordinal first memory access instruction of the plurality of memory access instructions is ready; and
responsive to determining that the data for the ordinal first memory access instruction is ready:
complete execution of the ordinal first memory access instruction; and
continue execution of the instruction stream.

17. The non-transitory computer-readable medium of claim 16, wherein:
the plurality of memory access instructions comprises the ordinal first memory access instruction and an ordinal second memory access instruction; and
the ordinal first memory access instruction is associated with a memory latency lower than a memory latency of the ordinal second memory access instruction.

18. The non-transitory computer-readable medium of claim 16, wherein the computer-executable instructions cause the processor device to continue execution of the instruction stream by causing the processor device to:
execute one or more instructions that are not dependent on an uncompleted memory access instruction; and
subsequently execute a second partial synchronization instruction that specifies a count of the remaining memory access instructions of the plurality of memory access instructions.

19. The non-transitory computer-readable medium of claim 16, wherein the computer-executable instructions further cause the processor device to:
identify, by executing a compiler, the plurality of memory access instructions in the instruction stream; and
insert the first partial synchronization instruction following an ordinal last memory access instruction of the plurality of memory access instructions.

20. The non-transitory computer-readable medium of claim 19, wherein the computer-executable instructions further cause the processor device to insert the first partial synchronization instruction responsive to determining that inserting the first partial synchronization instruction results in a benefit criteria being satisfied.
